(19) United States
(12) Patent Application Publication
(10) Pub. No.: US 2019/0040675 A1
(43) Pub. Date: Feb. 7, 2019

(54) SEAL WITH SHAPE MEMORY ALLOY ELEMENTS FOR ACTUATION AND HEATING

(71) Applicant: GM Global Technology Operations LLC, Detroit, MI (US)

(72) Inventors: Paul W. Alexander, Ypsilanti, MI (US); Nancy L. Johnson, Northville, MI (US); Mark O. Vann, Canton, MI (US)

(73) Assignee: GM Global Technology Operations LLC, Detroit, MI (US)

(21) Appl. No.: 16/027,918

(22) Filed: Jul. 5, 2018

Related U.S. Application Data
(60) Provisional application No. 62/541,186, filed on Aug. 4, 2017.

(51) Int. Cl. E06B 7/18; F16J 15/02

(52) U.S. Cl. CPC E06B 7/18; F16J 15/022

(57) ABSTRACT

A conditioned apparatus defines a chamber, and includes a frame defining a door opening providing access to the insulated chamber and a door movable relative to the frame. The door selectively blocks the door opening. A seal disposed between the frame and the door, and a shape memory alloy (SMA) element is associated with, and may be knitted directly into, the seal. A controller operatively connected to the SMA element. The controller selectively provides heat to the SMA element, such that the seal changes from spanning between the door and the frame, when the temperature of the SMA element is below a phase-change temperature, to contacting only one of the frame and the door, when the temperature of the SMA element is at least the phase-change temperature.

### CROSS-REFERENCE TO RELATED APPLICATIONS

This application claims the benefit of U.S. Provisional Application No. 62/541,186, filed Aug. 4, 2017, which is hereby incorporated by reference in its entirety.

### TECHNICAL FIELD

This disclosure generally relates to sealing of doors leading to insulated chambers.

### BACKGROUND

Chambers, such as insulated chambers in refrigerators, freezers, or ovens, include doors for selective access to the chamber. Seals are generally placed at some portions of the interface between the door and the entrance to the chamber. Additionally, conditioned or insulated chambers include the interior of passenger or industrial vehicles.

The seal, or seals, are configured to limit passage of heat energy at the interface of the door and the chamber, in order maintain the temperature (cooled or heated) within the insulated chamber while minimizing energy usage. Additionally, the seals may be configured to limit passage of pressure, air, moisture, or dust and debris. The doors may be large, particularly where the insulated chamber is configured to provide access to people or vehicles.

### SUMMARY

A conditioned apparatus is provided. The conditioned apparatus defines a chamber, or insulated chamber, and includes a frame defining a door opening providing access to the insulated chamber, and a door movable or slidable relative to the frame. The door is configured to selectively block the door opening.

A seal is disposed between the frame and the door, and a shape memory alloy (SMA) element is associated with the seal. A controller is operatively connected to the SMA element, and is configured to control the SMA element to selectively place the seal into at least a contact state and a released state. In the contact state, the seal spans between the door and the frame. In the released state, the seal is in contact with only one of the door and the frame.

The controller may place the seal into the contact state by providing substantially zero current to the SMA element, and may place the seal into the released state by providing an actuation current, which is greater than substantially zero, to the SMA element. The actuation current may increase the temperature of the SMA element to above a phase-change temperature for the shape memory alloy.

In some configurations, the controller also controls the SMA element to place the seal into a heating state, in which the seal spans between the door and the frame but in which the SMA element is introducing heat into the seal. The controller may place the seal into the heating state by providing a heating current, which is greater than zero but less than the actuation current, to the SMA element.

In some configurations, the SMA element is a plurality of SMA wires that are knitted into the seal. Additionally, the seal may substantially circumscribe the door opening.

The above features and advantages, and other features and advantages, of the present subject matter are readily apparent from the following detailed description of some of the best modes and other embodiments for carrying out the disclosed structures, methods, or both.

### BRIEF DESCRIPTION OF THE DRAWINGS

FIG. 1 is a schematic, front view of a conditioned apparatus, such as a walk-in cooler or freezer, accessible via a door opening, illustrating a slidable door and a seal insulating the barrier between the slidable door and the door opening.

FIG. 2A is a schematic, cross-sectional view of a portion of the conditioned apparatus, taken generally along line 2-2 of FIG. 1, illustrated with the seal in a contact state.

FIG. 2B is a schematic, cross-sectional view of a portion of the conditioned apparatus, taken generally along line 2-2 of FIG. 1, illustrated with the seal actuated or controlled to a released state.

FIG. 3A is a schematic, side view of another configuration of a seal and SMA element capable of actuating and heating the seal, illustrating intermittent or spaced SMA bands.

FIG. 3B is a schematic, end view of one configuration of a seal and SMA element capable of actuating and heating the seal, illustrating SMA wires that are partially knitted into a substrate of the seal.

FIG. 3C is a schematic, end view of another configuration of a seal and SMA element capable of actuating and heating the seal, illustrating accordion-type contraction or actuation to a released state.

### DETAILED DESCRIPTION

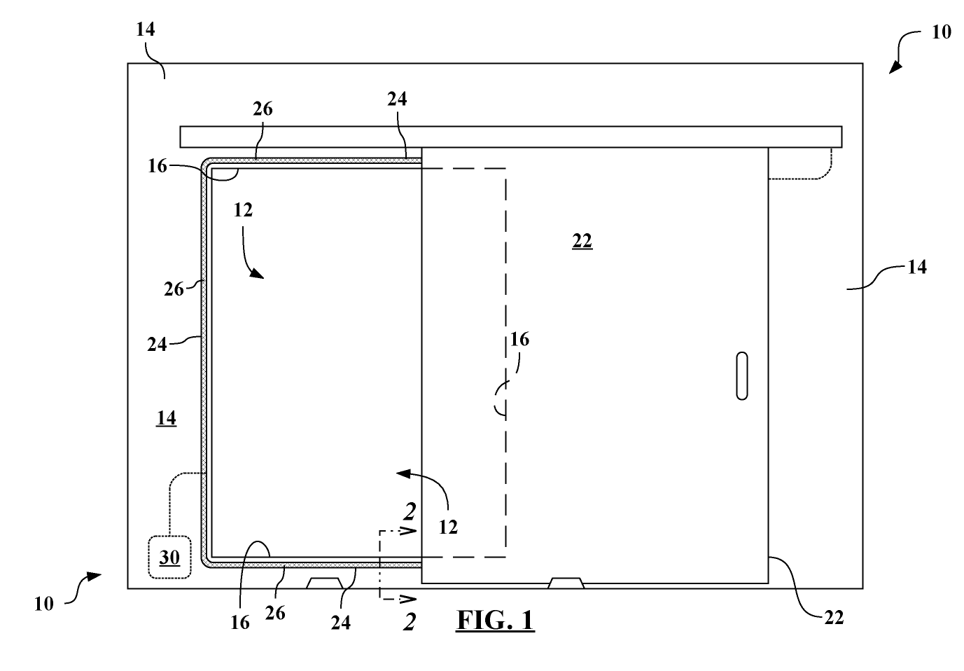

Referring to the drawings, like reference numbers correspond to like or similar components whenever possible throughout the several figures. There is shown in FIG. 1 a plane or front view of a conditioned apparatus 10, which defines an insulated chamber 12 therein. A frame 14 defines a door opening 16 that provides access to the insulated chamber 12. A door 22 is movable relative to the frame 14.

The door 22 selectively blocks the door opening 16. The door 22 is illustrated partially open in FIG. 1, and is slidable from a far leftward position, as viewed in FIG. 1, to completely close and block the door opening 16, to a far rightward position, as viewed in FIG. 1, allowing maximum access to the door opening 16.

In many instances, the insulated chamber 12 will be cooled, such that the conditioned apparatus 10 is either a refrigerator or freezer, and may be a walk-in or drive-in cooler. However, the elements described herein may also be usable with, and useful for, heated chambers, such as large ovens or curing rooms. The door 22 may be a metal door, a wooden door, a composite door, or combinations thereof. Furthermore, the door 22 may have fabric or membrane components or layers. Large doors 22, such as those used in drive-in units, may be particularly likely to utilize fabric or membrane constructions, which may be particularly susceptible to wear and tear caused by friction.

Additionally insulated chambers 12 may be found in industrial or passenger vehicles, including the cabins or passenger compartments thereof. Varying amounts of insulation may be used to maintain the conditioned environment within the insulated chamber 12. Furthermore, rail cars, airplanes, or trucking containers may include insulated chambers 12 covered by the disclosure herein. Various insulated chambers 12 accessible via various doors 22—whether slidable, pivotable, or otherwise movable relative to the insulated chamber 12—may incorporate features discussed herein. The conditioned environment within the insulated chamber 12 may be used for the benefit of goods, people, or both. The embodiments or configurations discussed or illustrated herein are only examples, including the relationship between the door 22 and the insulated chamber 12, and do not limit the scope of the claimed invention to specific industries or uses.

A sealing bulb or seal 24 is disposed between the frame 14 and the door 22. A portion of the seal 24 is viewable around the perimeter of the door opening 16 in FIG. 1. In the configuration shown, the seal 24 may substantially circumscribe the door opening 16. However, some configurations of the seal 24, such as those in which no portion of the frame 14 extends upward from ground level at the door opening 16, may not fully circumscribe the door opening 16. In such a configuration, the bottom (as viewed in FIG. 1) of the door 22 may include an additional sealing element between the door 22 and the floor. There may also be discontinuities in the seal 24, such that it effectively, but not continuously, circumscribes the door opening 16. Note, also, that there may be additional insulation beyond, relative to the door opening 16, the perimeter of the seal 24.

While the present disclosure may be described with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

In the configuration shown in FIG. 1, the seal 24 is mounting on, or attached to, the frame 14. However, in other configurations, the seal 24 may be mounted on, or attached to, the door 22. In either configuration, or in one in which the seal 24 floats between the two components, the seal 24 limits passage of heat energy or conditioned air by normally spanning between the door 22 and the frame 14. The seal 24 may also limit passage of dust and debris, pressure, and water or moisture, in order to maintain the desired environment for goods, people, or both, within the insulated chamber 12.

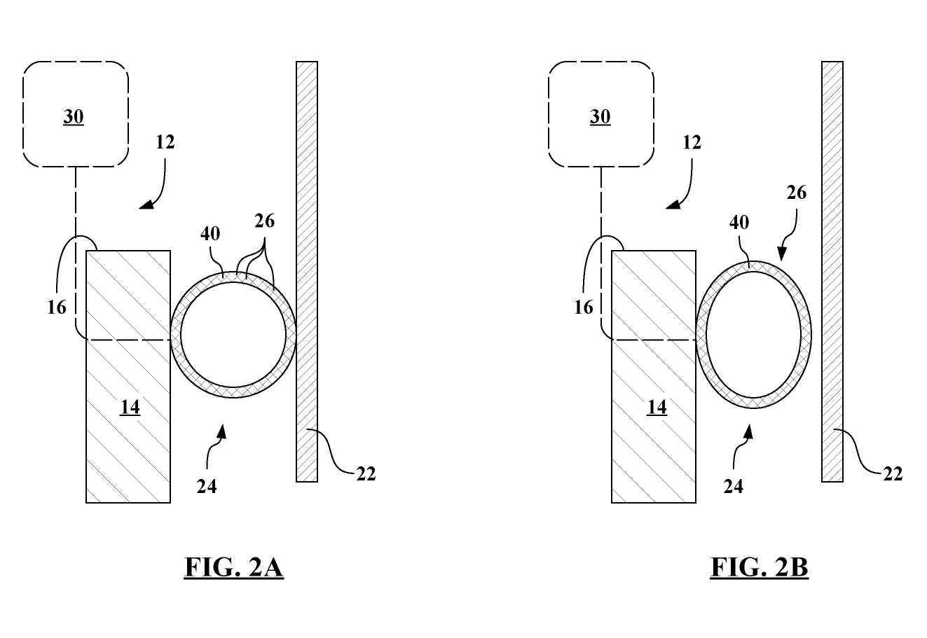

As shown in FIG. 1, the door 22 slides relative to the frame 14, as opposed to swinging between open and closed positions. Therefore, portions of the seal 24 may be placed into frictional contact with either the door 22 or the frame 14. As discussed herein, there is a shape memory alloy (SMA) element, or SMA element 26 (illustrated in more detail in FIGS. 2A and 2B,) associated with the seal 24. The SMA element 26 is configured to selectively reduce frictional contact between the seal 24 and the door 22 or the frame 14.

Referring also to FIG. 2A and FIG. 2B, and with continued reference to FIG. 1, there are shown two possible states, configurations, or actuations of the seal 24 relative to the door 22. Through selective control of the SMA elements 26, the seal may be placed into various states, including at least a contact state, as shown in FIG. 2A, and a released state, as shown in FIG. 2B.

The contact state, in which the seal 24 spans between the door 22 and the frame 14, may be used when the door 22 is fully closed, or whenever the door 22 is not sliding relative to the frame 14. The released state, in which the seal 24 is in contact with only one of the door 22 and the frame 14, may be used when the door 22 is not fully closed, or whenever the door 22 is sliding relative to the frame 14. Note that while the seal 24 is illustrated as being attached to the frame 14 in FIGS. 1, 2A and 2B, the same principles apply when the seal 24 is attached to the door 22.

A control system or controller 30 is operatively connected to the SMA element 26. The controller 30 is configured to control the SMA element 26 to selectively place or actuate the seal 24 between, at least, the contact state and the released state. Furthermore, as described herein, the controller 30 may control the SMA element 26 to place the seal 24 into a defrost or heating state.

The controller 30 includes sufficient memory and processing power to execute the functions, and equivalents thereof, described herein, and to interact with the components, and equivalents thereof, described herein. Skilled artisans will recognize numerous control architectures that may be used to execute any and all of the functions described herein, in addition to equivalents or modifications. The controller 30 may be in functional communication with one or more sensors (not shown). For example, the conditioned apparatus 10 may have temperature sensors or sensors configured, in association with the controller 30, to determine when the door 22 is open, moving, or about to move.

As used herein, the term, “shape memory alloy,” refers to an alloy that exhibits a shape memory effect and has the capability to quickly change properties in terms of stiffness, spring rate, form (such as length or curvature), or combinations thereof. The shape memory alloy may undergo a solid state crystallographic phase change via molecular or crystalline rearrangement to shift between a martensite phase, i.e., “martensite”, and an austenite phase, i.e., “austenite”. That is, the shape memory alloy may undergo a displacive transformation rather than a diffusional transformation to shift between martensite and austenite.

A displacive transformation is a structural change that occurs by a coordinated movement of atoms or groups of atoms relative to neighboring atoms or groups of atoms. Further, the martensite phase generally refers to a comparatively lower-temperature phase and is often more deformable than the comparatively higher-temperature austenite phase.

The temperature at which the shape memory alloy begins to change from the austenite phase to the martensite phase is characterized as the martensite start temperature, Ms. The temperature at which the shape memory alloy completes the change from the austenite phase to the martensite phase is characterized as the martensite finish temperature, Mf. Similarly, as the shape memory alloy is heated, the temperature at which the shape memory alloy begins to change from the martensite phase to the austenite phase is characterized as the austenite start temperature, As. The temperature at which the shape memory alloy completes the change from the martensite phase to the austenite phase is characterized as the austenite finish temperature, Af.

The shape memory alloy may have a suitable form, i.e., shape. For example, the SMA element 26 may be configured as a shape-changing element such as one or more wires, springs, bands, or combinations thereof. Further, the shape memory alloy may have a suitable composition. In particular, the shape memory alloy may include in combination an element selected from the group of cobalt, nickel, titanium, indium, manganese, iron, palladium, zinc, copper, silver, gold, cadmium, tin, silicon, platinum, and gallium. For example, in addition to those alloys recognized by skilled artisans, suitable shape memory alloys may include nickel-titanium based alloys, nickel-aluminum based alloys, nickel-gallium based alloys, indium-titanium based alloys, indium-cadmium based alloys, nickel-cobalt-aluminum based alloys, nickel-manganese-gallium based alloys, copper based alloys (e.g., copper-zinc alloys, copper-aluminum alloys, copper-gold alloys, and copper-tin alloys), gold-cadmium based alloys, silver-cadmium based alloys, manganese-copper based alloys, iron-platinum based alloys, iron-palladium based alloys, and combinations of one or more of each of these combinations.

The shape memory alloy forming the SMA element 26 can be binary, ternary, or a higher order so long as the shape memory alloy exhibits a shape memory effect, e.g., a change in shape orientation. Generally, the shape memory alloy may be selected according to desired operating temperatures of the SMA element 26 and the seal 24. In one specific example, the shape memory alloy may include nickel and titanium.

Increasing temperature of the SMA to move from the martensite phase to the austenite phase may result in a change in form of the SMA element 26. For example, and without limitation, portions of the SMA may move from curved to straight, from straight to curved, may experience a reduction in size, or any combination thereof.

In the configuration shown in FIGS. 2A and 2B, the SMA element 26 is a plurality of SMA wires. The seal 24 may be formed from a substrate 40, such as a rubber, neoprene, or another suitable material for limiting thermal energy passage to, or from, the insulated chamber 12 through the seal 24. The SMA wires may be embedded within the substrate 40.

The SMA wires forming the SMA element 26 may be knitted into the substrate 40. Furthermore, the SMA wires of the SMA element 26 may be the only wires, or may be knitted in addition to other wires or fibers. For example copper or aluminum wires may form a portion of the knit.

In the wire, or knitted wire, form, the SMA element 26 may contract in length in response to an increase in temperature to above the phase-change temperature. Alternatively, the wires may become curved, or may straighten in response to a sufficient increase in temperature.

The change in temperature may be effected by heat such as from Joule heating as an electric current is passed through the SMA wires. Furthermore, the change in temperature of the SMA element 26 may occur as a result of an external heat source, such as a radiative heating element, a ceramic heating element, a resistive heating element, or inductive heating. Therefore, the SMA element 26 may transition between a first, low-temperature, state and a second, higher-temperature, state to move the seal 24 from the contact state to the released state.

For example, contraction in length of the SMA wires forming the illustrated SMA element 26 provides sufficient force to move, or retract, portions of the seal 24 away from the door 22. Note that, in any of the embodiments disclosed herein, one or more force transmission elements may be disposed to interface with the SMA wires to amplify, guide, or redirect its contraction or other shape change. For example, and without limitation, lever arms, gears, or sliding elements may interface with the SMA wires of the SMA element 26 or portions of the seal 24.

When the temperature of the SMA element 26 is below the austenite start temperature, the seal 24 will likely be in the contact state, such that it spans between the frame 14 and the door 22. Generally, activation or actuation of the SMA element 26 may be considered to occur between the austenite start temperature and the austenite finish temperature. In many configurations, the controller 30 will raise the SMA element 26 to, or above, the austenite finish temperature in order to place the seal 24 into the retracted state. However, controlled actuation to a temperature between the austenite start temperature and the austenite finish temperature may also be utilized.

The controller 30 is operatively connected to the SMA wire, or wires, forming the SMA element 26, such that the controller 30 is configured to control the SMA element 26 to place the seal 24 into the contact state and the released state. In many configurations, the controller 30 will effect temperature changes within the SMA element 26 via induction or by passing current through the SMA element 26 to create resistance heating.

Where the controller 30 effects temperature changes via resistance heating, the controller 30 may place the seal 24 into the contact state by providing substantially zero current to the SMA element 26. Note, however, that some current may flow through the SMA element 26 during the contact state.

Similarly, the controller 30 may place the seal 24 into the released state by providing an actuation current, which is greater than zero, to the SMA element 26. In particular, the actuation current may be configured to increase the temperature of the SMA element 26 to above its phase-change temperature, i.e., to above at least the austenite start temperature, if not the austenite finish temperature. Depending on the type of shape memory alloy used in the SMA element 26, the phase-change temperature may be between, approximately, 90-100 degrees Celsius.

When the controller 30 is providing substantially no current to the SMA element 26, the temperature of the seal 24 will be a result of the temperature within the insulated chamber 12, the ambient air surrounding the conditioned apparatus 10, and the effectiveness of the insulation provided by the seal 24 therebetween. In many instances, such as where the conditioned apparatus 10 is a walk-in freezer, frost or ice may form on the seal 24, or on the interface between the seal 24 and either, or both, the door 22 or the frame 14.

The controller 30 of the conditioned apparatus 10 may also be configured to control the SMA element 26 to place the seal 24 into a heating state, in which the seal 24 spans between the door 22 and the frame 14, but in which the SMA element 26 is introducing heat into the seal 24. For example, the controller 30 may place the seal 24 into the heating state by providing a heating current, which is greater than zero but less than the actuation current, to the SMA element 26.

When the controller 30 is placing the SMA element 26 and the seal 24 into the heating state, the SMA element 26 has not reached the phase-change temperature, such that it is not contracting the seal 24. However, the current running through the SMA element 26 is creating resistive heat energy, such that the seal 24 is defrosted or heated. The heating state allows the conditioned apparatus 10 to minimize formation of frost or ice between the seal 24 and the door 22 or the frame 14. Formation of frost or ice may create friction between the seal 24 and either the door 22 or the frame 14 or may cause the seal 24 to stick to adjacent structures, which may result in wear and tear to the door 22, the frame 14, or the seal 24.

Furthermore, note that the heating state brings the temperature of the SMA element 26 nearer to its phase-change, and actuation, temperature. Therefore, the heating state may shorten the amount of time, and the amount of additional energy, needed or supplied to actuate the SMA element 26 into the retracted state. For example, and without limitation, if the phase-change temperature of the SMA element 26 is around 90 degrees Celsius, bringing the SMA element to between 40-50 degrees Celsius may cut the time and energy needed to actuate the SMA element 26 in, approximately, half. Additionally, 40-50 degrees Celsius should be sufficient to defrost the seal 24.

The various resistive heating configurations described herein, as well as those recognizable by skilled artisans, are also analogous to inductive heating. For inductive heating configurations, the controller 30 supplies alternating current to an electromagnet, resulting in eddy currents that cause temperature changes within the SMA element 26, which is within the induction field. Variations in the amount of alternating current supplied will vary the resulting temperature change within the SMA element 26.

Additional mechanisms for effecting temperature changes in the SMA element 26 may include conductive heating. For example, a heated fluid may be circulated within the interior of the seal 24, such that the SMA element 26 is selectively heated to either its phase-change temperature or to an intermediate, defrosting, temperature.

Furthermore, conductive heating may occur via resistance heating of nearby, non-SMA, wires that are knitted—including co-knitted with SMA wires—into the seal 24. Copper or aluminum wires could be used to provide conductive heating to nearby SMA wires of the SMA element 26. Such a configuration may allow greater flexibility for the orientation of SMA wires within the seal 24, and may negate the need for the SMA wires to form a complete circuit for passage of current there through. Conductive heating via nearby copper wires may allow the SMA wires to be woven, as opposed to knitted, within the seal 24. Similarly, inductive heating may expand the available configurations of the SMA wires, as the wires will not need to form a complete circuit.

Formation or manufacture of the combined structure of the seal 24 and the SMA element 26 may occur through several methods. Several examples, without limitation, for forming the seal 24 and the SMA element 26 are discussed herein. Other methods or techniques for forming the seal 24 and the SMA element 26 will be apparent to skilled artisans in light of this disclosure.

One or more SMA wires may be knitted in two or three dimensions to form a, generally, tubular structure for the SMA element 26. Then, the substrate 40 may be overmolded or impregnated onto the knitted SMA wires, forming the seal 24 around the SMA element 26.

Additionally, the substrate 40 may be preformed as either a tube or a flat sheet—that could then be curved into a tubular shape—and one or more SMA wires may be knitted into the substrate 40 to place the SMA element 26 within the seal 24. Furthermore, a plurality of plastic or rubber fibers or wires may be co-knitted or woven with the SMA wires, such that the resulting sheet or tube would be porous. The combined structures could then be heated to melt—and subsequently solidify—resulting in a non-porous substrate 40 surrounding the SMA element 26

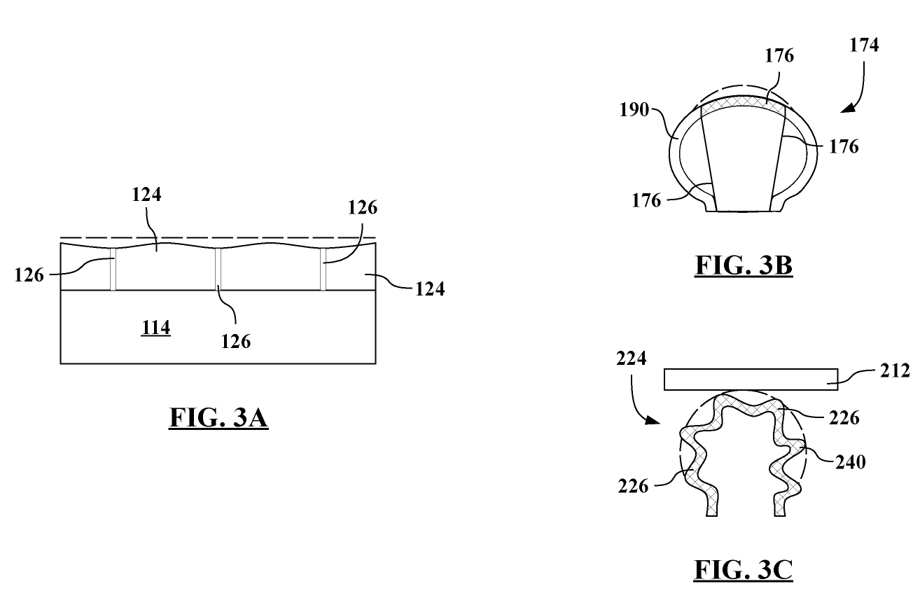

Referring also to FIG. 3A, FIG. 3B, and FIG. 3C, in addition to FIGS. 1-2B, there are shown additional configurations of SMA elements and seals. FIG. 3A shows intermittent bands of SMA, FIG. 3B shows a partial knit of SMA, and FIG. 3C shows an accordion retracted state.

In the schematic illustration of FIG. 3A, a frame 114 supports a seal 124. A plurality of intermittent or spaced SMA bands form SMA elements 126. The intermittent SMA elements 126 are configured to contract in response to temperature increases above the phase-change temperature (such as the austenite finish temperature).

Contraction of the SMA elements 126 causes movement of the seal 124 away from a contact state (illustrated by a dashed line) to a retracted state, which is shown in FIG. 3A. Although the SMA elements 126 are intermittent, they may be spaced sufficiently close to cause all, or substantially all, of the seal 124 to retract relative to adjacent sliding structures. Furthermore, the SMA elements 126 may be placed into a heating state, and the seal 124 may conduct heat to defrost the interface of the seal 124 with the frame 114 and a sliding door.

In the schematic illustration of FIG. 3B, a seal 174 is shown in a retracted state, with a contact state illustrated by dashed lines. In the configuration shown, a plurality of SMA wires form an SMA element 176 that is partially knitted into a substrate 190 of the seal 174.

Only a portion of the substrate 190 includes the knitted SMA element 176. Additionally, SMA wires forming a portion of the SMA element 176 connect the knitted portion with the base of the seal 174, or with the structures to which the seal 174 is attached. As the temperature of the SMA element 176 is raised, such as by resistive heating, the SMA element 176 contracts, causing movement of the seal 174 toward its base, as shown in FIG. 3B.

Other partially knitted configurations may be used. For example, the sides of the seal 174, as opposed to the top (as viewed in FIG. 3B), may have the SMA wires embedded therein.

Additionally, note that the SMA wires used in the SMA element 176, and the other SMA elements discussed herein, may be connected to other, non-SMA wires or conductive elements. For example, and without limitation, the SMA wires may be electrically connected to copper wires, reducing the amount of shape memory alloy used. Additionally, copper wires may reduce the need for the SMA to span entirely—i.e., forming a complete electrical circuit—between the electrical contact points of the relevant control system.

In the schematic illustration of FIG. 3C, a door 212 is slidable relative to a seal 224. The seal 224 is shown in a retracted state, resulting from actuation of an SMA element 226. A contact state for the seal 224 is schematically illustrated by dashed lines.

In the configuration shown, a plurality of SMA wires form the SMA element 226. The SMA wires are knitted into substantially the entirety of a substrate 240 of the seal 224, which is formed into a partial tube. The retracted state of the SMA element 226 and the seal 224, unlike some of the other configurations described herein, moves into an accordion-like shape.

Activation, such as contraction of the knitted SMA wire of the SMA element 226 causes portions of the seal 224 to flex inward. This inward flexure may be controlled or calculated such that the seal 224 is removed from contact with the door 212. Alternatively, the seal 224 may be largely removed from contact with the door 212, such that the amount of frictional engagement is greatly reduced, relative to the contact state. Like the other configurations, the SMA element 226 may be placed into a heating mode, via intermediate levels of resistive or inductive heating, to defrost the seal 224.

Note that, unlike the configuration shown in FIGS. 2A and 2B, the seal 174 of FIG. 3B and the seal 224 of FIG. 3C are not complete tubes. Instead, the seal 174 and the seal 224 may have been formed as sheets, which are then formed into partial tubes or initially formed as partial tubes. The seals 174, 224 may then be attached to a structure, such as a frame or a slidable door (not shown). Any of the configurations discussed herein, as well as those recognized by skilled artisans, may be formed as tubes, partial tubes, or other shapes.

The term “substantially” may refer to relationships that are, ideally, perfect or complete, but where manufacturing realties or engineering needs prevent absolute perfection. The needs of actual production workpieces may also result in “substantially” referring to lesser coverage or amounts, or to discontinuities.

Therefore, “substantially” often denotes typical variance from perfection, or incorporation of engineering needs and limitations, particularly based on requirements of the final product. For example, if height A is substantially equal to height B, it may, generally, be preferred that the two heights are 100.0% equivalent. However, manufacturing realities likely result in the distances varying from such perfection. Skilled artisans would recognize the amount of acceptable variance in the relevant art. For example, in many industries, coverages, areas, or distances may generally be within 10% of perfection for substantial equivalence. Similarly, relative alignments, such as parallel or perpendicular, may generally be considered to be within 5%.

Those having ordinary skill in the art will recognize the breadth of the relative term, “substantially,” as applied to the elements, limitations, and components herein. For example, and without limitation, when referring to SMA wires knitted being throughout substantially the entire seal, the term may denote that the SMA wires are dispersed through the entire, or close to the entire, working portion of the sealing substrate. However, flanges or other portions used to attach the seal to adjacent structures may not have the knitted SMA wires incorporated therein.

The detailed description and the drawings or figures are supportive and descriptive of the subject matter discussed herein. While some of the best modes and other embodiments for have been described in detail, various alternative designs, configurations, and embodiments exist.

1. A conditioned apparatus defining an insulated chamber, comprising:
a frame defining a door opening providing access to the insulated chamber;
a door slidable relative to the frame, and configured to selectively block the door opening;
a seal disposed between the frame and the door;
a shape memory alloy (SMA) element associated with the seal; and
a controller operatively connected to the SMA element, and configured to control the SMA element to selectively place the seal into:
a contact state, in which the seal spans between the door and the frame; and
a released state, in which the seal is in contact with only one of the door and the frame.

2. The conditioned apparatus of claim 1, further comprising:
wherein the controller places the seal into the contact state by providing substantially zero current to the SMA element; and
wherein the controller places the seal into the released state by providing an actuation current, which is greater than substantially zero, to the SMA element.

3. The conditioned apparatus of claim 2, wherein the actuation current increases the temperature of the SMA element to above a phase-change temperature.

4. The conditioned apparatus of claim 3, wherein the controller is further configured to control the SMA element to place the seal in:
a heating state, in which the seal spans between the door and the frame and in which the SMA element is introducing heat into the seal.

5. The conditioned apparatus of claim 4, wherein the controller places the seal into the heating state by providing a heating current, which is greater than zero but less than the actuation current, to the SMA element.

6. The conditioned apparatus of claim 5, wherein the SMA element is knitted into the seal.

7. The conditioned apparatus of claim 6, wherein the seal substantially circumscribes the door opening.

8. The conditioned apparatus of claim 1, further comprising:
wherein the controller places the seal into the released state by heating the SMA element to above its phase-change temperature.

9. The conditioned apparatus of claim 1, wherein the SMA element is a plurality of knitted SMA wires.

10. The conditioned apparatus of claim 9, wherein a substrate of the seal is overmolded onto the knitted SMA wires of the SMA element.

11. The conditioned apparatus of claim 9, wherein a plurality of rubber fibers are knitted with the knitted SMA wires, such that heating the rubber fibers forms a substrate substantially encasing the knitted SMA wires.

12. A conditioned apparatus defining an insulated chamber, comprising:
a frame defining a door opening providing access to the insulated chamber;
a door movable relative to the frame, and configured to selectively block the door opening;
a seal disposed between the frame and the door;
a shape memory alloy (SMA) element associated with the seal; and
a controller operatively connected to the SMA element, wherein the controller selectively provides heat to the SMA element, such that the seal changes from spanning between the door and the frame, when the temperature of the SMA element is below a phase-change temperature, to contacting only one of the frame and the door, when the temperature of the SMA element is at least the phase-change temperature.

13. The conditioned apparatus of claim 12, wherein the SMA element is a plurality of SMA wires knitted into the seal.

14. The conditioned apparatus of claim 13, wherein the SMA wires are knitted throughout substantially the entire seal.
